(19) United States
(12) Patent Application Publication
(10) Pub. No.: US 2014/0218840 A1
(43) Pub. Date: Aug. 7, 2014

(54) DIELECTRIC COMPOSITION AND MULTILAYER CERAMIC ELECTRONIC COMPONENT USING THE SAME

(71) Applicant: SAMSUNG ELECTRO-MECHANICS CO., LTD., Suwon (KR)

(72) Inventors: Sung Hyung KANG, Suwon (KR); Ki Yong LEE, Suwon (KR); Han Nah CHANG, Suwon (KR); Du Won CHOI, Suwon (KR); Jae Hun CHOE, Suwon (KR); Min Sung SONG, Suwon (KR)

(73) Assignee: SAMSUNG ELECTRO-MECHANICS CO., LTD., Suwon (KR)

(21) Appl. No.: 13/871,989

(22) Filed: Apr. 26, 2013

(30) Foreign Application Priority Data
Feb. 6, 2013 (KR) 10-2013-0013269

(51) Int. Cl. C04B 35/468; H01G 4/018; H01G 4/08

(52) U.S. Cl. CPC C04B 35/4682; H01G 4/08; H01G 4/018
USPC 361/303; 501/152; 501/134; 501/137

(57) ABSTRACT

There are provided a dielectric composition and a multilayer ceramic electronic component using the same, the dielectric composition including dielectric grains having a perovskite structure represented by ABO₃, wherein the dielectric grain includes a base material, in which at least one rare earth element RE is solid-solubilized in at least one of A and B, and a transition element TR, and a ratio (TR/RE) of the transition element to the rare earth element is 0.2 to 0.8.

### CROSS-REFERENCE TO RELATED APPLICATIONS

This application claims the priority of Korean Patent Application No. 10-2013-0013269 filed on Feb. 6, 2013, in the Korean Intellectual Property Office, the disclosure of which is incorporated herein by reference.

### BACKGROUND OF THE INVENTION

1. Field of the Invention

The present invention relates to a dielectric composition having excellent dielectric characteristics and electrical characteristics, and a multilayer ceramic electric component using the same.

2. Description of the Related Art

In general, perovskite powder, a ferroelectric ceramic material, is used as a raw material for an electronic component such as a multilayer ceramic capacitor (MLCC), a ceramic filter, a piezoelectric element, a ferroelectric memory, a thermistor, a varistor, or the like.

Barium titanate (BaTiO₃), a high-k dielectric material having a perovskite structure, is used as a dielectric material in a multilayer ceramic capacitor.

In accordance with the recent trend for slimness, lightness, high capacitance and high reliability within the electronic components industry, a ferroelectric particle having a small size, excellent permittivity and excellent reliability has been required.

When an average particle size of barium titanate powder, a main component of a dielectric layer, is relatively large, a surface roughness of the dielectric layer may be increased, such that a short-circuit generation rate may be increased, and insulation resistance defects may be generated.

Therefore, atomization of barium titanate powder, the main component of multilayer ceramic capacitors, has been required.

However, as barium titanate powder is atomized and the thickness of dielectric layers of multilayer ceramic electronic components is reduced, problems such as a decrease in capacitance, short circuits, reliability defects, and the like, may be generated.

Therefore, the development of a multilayer ceramic electronic component capable of securing permittivity in the dielectric layer and having excellent reliability has remained in demand.

### RELATED ART DOCUMENT

(Patent Document 1) Japanese Patent Laid-open Publication No. 2008-239407

### SUMMARY OF THE INVENTION

An aspect of the present invention provides a dielectric composition having excellent dielectric characteristics and electrical characteristics, and a multilayer ceramic electric component using the same.

According to an aspect of the present invention, there is provided a dielectric composition including: dielectric grains having a perovskite structure represented by ABO₃, wherein the dielectric grain includes a base material, in which at least one rare earth element RE is solid-solubilized in at least one of A and B, and a transition element TR, and a ratio (TR/RE) of the transition element to the rare earth element is 0.2 to 0.8.

A content of the rare earth element RE in the form of an oxide may be 0.1 to 1.2 at %, based on the base material.

A content of the transition element TR in the form of an oxide may be 0.02 to 0.8 at %, based on the base material.

A may include at least one selected from a group consisting of barium (Ba), strontium (Sr), lead (Pb), and calcium (Ca).

B may include at least one selected from a group consisting of titanium (Ti) and zirconium (Zr).

The rare earth element may be at least one selected from a group consisting of scandium (Sc), yttrium (Y), lanthanum (La), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

The dielectric grain may include at least one selected from a group consisting of BaₘTiO₃ (0.995≦m≦1.010), (Ba₁₋ₓCaₓ)ₘ(Ti_{1-y}Zr_{y})O₃ (0.995≦m≦1.010, 0≦x≦0.10, 0<y≦0.20), and Baₘ(Ti₁₋ₓZrₓ)O₃ (0.995≦m≦1.010, x≦0.10).

According to another aspect of the present invention, there is provided a multilayer ceramic electronic component including: a ceramic body including dielectric layers having an average thickness of 0.65 μm or less; and internal electrodes disposed to face each other within the ceramic body, having the dielectric layer interposed therebetweeen, wherein the dielectric layer includes a dielectric composition including dielectric grains having a perovskite structure represented by ABO₃, the dielectric grain including a base material, in which at least one rare earth element RE is solid-solubilized in at least one of A and B, and a transition element TR, and a ratio (TR/RE) of the transition element to the rare earth element being 0.2 to 0.8.

A content of the rare earth element RE in the form of an oxide may be 0.1 to 1.2 at %, based on the base material.

A content of the transition element TR in the form of an oxide may be 0.02 to 0.8 at %, based on the base material.

A may include at least one selected from a group consisting of barium (Ba), strontium (Sr), lead (Pb), and calcium (Ca).

B may include at least one selected from a group consisting of titanium (Ti) and zirconium (Zr).

The rare earth element may be at least one selected from a group consisting of scandium (Sc), yttrium (Y), lanthanum (La), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

The dielectric grain may include at least one selected from a group consisting of BaₘTiO₃ (0.995≦m≦1.010), (Ba₁₋ₓCaₓ)ₘ(Ti_{1-y}Zr_{y})O₃ (0.995≦m≦1.010, 0<x≦0.10, 0<y≦0.20), and Baₘ(Ti₁₋ₓZrₓ)O₃ (0.995≦m≦1.010, x≦0.10).

The dielectric layer may have a permittivity of 6500 or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention; and

FIG. 2 is a cross-sectional view taken along line B-B′ of FIG. 1.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

A dielectric composition according to an embodiment of the invention may include dielectric grains having a perovskite structure represented by ABO₃, wherein the dielectric grain includes a base material in which at least one rare earth element RE is solid-solubilized in at least one of A and B and a transition element TR, and a ratio (TR/RE) of the transition element to the rare earth element may be 0.2 to 0.8.

Hereinafter, the dielectric composition according to the embodiment of the invention will be described in detail.

According to the embodiment of the invention, the dielectric composition may include a dielectric grain 10 having a perovskite structure represented by ABO₃.

Here, A may include at least one selected from a group consisting of barium (Ba), strontium (Sr), lead (Pb), and calcium (Ca), but is not limited thereto.

Here, B is not particularly limited, and any material may be used therefor as long as it may be positioned at a B site in the perovskite structure. For example, B may include at least one selected from a group consisting of titanium (Ti) and zirconium (Zr).

The dielectric grain may include a base material in which at least one rare earth element RE is solid-solubilized in at least one of A and B and a transition element TR.

That is, the base material may have a form in which at least one rare earth element RE is solid-solubilized in at least one of elements that may be positioned at an A or the B site in the perovskite structure as described above.

Therefore, the dielectric grain may include at least one selected from a group consisting of BaₘTiO₃ (0.995≦m≦1.010), (Ba₁₋ₓCaₓ)ₘ(Ti_{1-y}Zr_{y})O₃ (0.995≦m≦1.010, 0≦x≦0.10, 0<y≦0.20), and Baₘ(Ti₁₋ₓZrₓ)O₃ (0.995≦m≦1.010, x≦0.10) in which at least one rare earth element RE is solid-solubilized in at least one of A and B, but is not limited thereto.

The rare earth element RE may include trivalent ions, but is not limited thereto.

The rare earth element RE is not particularly limited, but may be, for example, at least one selected from a group consisting of scandium (Sc), yttrium (Y), lanthanum (La), Actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In addition, the dielectric grain may include the transition element TR as an additive, but is not limited thereto. In order to implement a high degree of permittivity, as well as excellent insulation and reliability characteristics, various additives may be added.

The transition element TR is not particularly limited, but may be, for example, at least one selected from a group consisting of chromium (Cr), molybdenum (Mo), tungsten (W), manganese (Mn), iron (Fe), cobalt (Co), and nickel (Ni). The transition element TR may be included in the dielectric grain in an oxide form.

Generally, as the dielectric grain included in the dielectric composition is atomized and a thickness of a dielectric layer of a multilayer ceramic electronic component using the dielectric grain is reduced, problems such as short circuits, reliability defects, or the like, may be generated.

In addition, at the time of preparing slurry using the atomized dielectric powder, it may be difficult to disperse the powder, such that the reliability of the multilayer ceramic electronic component manufactured using the dielectric composition may be deteriorated.

In order to solve the problem of reliability deterioration, the dielectric grain including an oxide having a perovskite structure in which the rare earth element RE is completely solid-solubilized as the base material may be more preferably used.

Further, in order to solve the problem of reliability deterioration, the dielectric grain including a predetermined amount of the transition element TR may be more preferably used.

That is, in order to solve the problems of short circuits and reliability defects generated as the thickness of the dielectric layer of the multilayer ceramic electronic component is reduced, content distribution of the rare earth element RE and the transition element TR in the dielectric grain having the perovskite structure needs to be adjusted.

According to the embodiment of the invention, the ratio (TR/RE) of the transition element to the rare earth element included in the dielectric grain may be 0.2 to 0.8, but is not limited thereto.

The dielectric grain may have a shell grain structure rather than a general core-shell structure.

The shell grain structure means that most of the various elements included in the grain as additives have a shell structure rather than a core-shell structure.

According to the embodiment of the invention, excellent insulation and reliability characteristics as well as high permittivity may be realized by controlling the ratio (TR/RE) of the transition element to the rare earth element included in the dielectric grain to 0.2 to 0.8.

In the case in which the ratio (TR/RE) of the transition element to the rare earth element is less than 0.2, permittivity may be high, but it may be difficult to realize desired insulation resistance characteristics and excellent reliability characteristics.

Meanwhile, in the case in which the ratio (TR/RE) of the transition element to the rare earth element is higher than 0.8, a desired degree of permittivity may not be obtained, and the reliability characteristics may also be deteriorated.

The content of the rare earth element RE in the form of an oxide may be 0.1 to 1.2 at %, based on the base material, but is not limited thereto.

The content of the rare earth element RE in the form of the oxide is controlled so as to be in a range of 0.1 to 1.2 at %, based on the base material, such that problems such as a decrease in permittivity and reliability defects in the multilayer ceramic electronic component using the dielectric composition including the dielectric grain may be solved.

In the case in which the content of the rare earth element RE in the form of the oxide is less than 0.1 at %, based on the base material, reliability may not be improved.

Meanwhile, in the case in which the content of the rare earth element RE in the form of the oxide is higher than 1.2 at %, based on the base material, a desired high degree of permittivity may not be obtained.

The content of the transition element TR in the form of an oxide is controlled so as to be in a range of 0.02 to 0.8 at %, based on the base material, such that problems such as a decrease in permittivity and reliability defects in the multilayer ceramic electronic component using the dielectric composition including the dielectric grain may be solved.

In the case in which the content of the transition element TR in the form of the oxide is less than 0.02 at %, based on the base material, reliability may not be improved.

Meanwhile, in the case in which the content of the transition element TR in the form of the oxide is higher than 0.8 at %, based on the base material, a desired high degree of permittivity may not be obtained.

The contents of the rare earth element RE and the transition element TR in the form of the oxide may mean atomic percentage (at %) of the elements based on the base material.

For example, in the case of dysprosium oxide (Dy₂O₃) among the rare earth elements, a value of the added rare earth element may be calculated by multiplying a mole number of the dysprosium oxide (Dy₂O₃) by 2, and in the case of manganese oxide (Mn₃O₄) among the transition elements, a value of the added transition element may be calculated by multiplying a mole number of the manganese oxide (Mn₃O₄) by 3.

That is, the atomic percent (at %) of dysprosium (Dy) based on 100 mol % of the base material may be calculated by dividing the mole number of the dysprosium oxide (Dy₂O₃) by 2 and then multiplying the obtained value by 1/100.

In addition, the atomic percent (at %) of manganese (Mn) based on 100 mol % of the base material may be calculated by dividing the mole number of the manganese oxide (Mn₃O₄) by 3 and then multiplying the obtained value by 1/100.

In the dielectric composition according to the embodiment of the invention, other additives may be additionally added in order to block a firing temperature from being decreased or further improve properties.

The additive is not particularly limited, but may be, for example, oxides of magnesium (Mg), barium (Ba), silicon (Si), vanadium (V), aluminum (Al), calcium (Ca), or the like.

The dielectric grain included in the dielectric composition according to the embodiment of the invention may be prepared using the following method.

The perovskite powder is powder having an ABO₃ type structure. In the embodiment of the invention, the metal oxide is the source of an element corresponding to a B site, and the metal salt is the source of an element corresponding to an A site.

First, a perovskite particle core may be formed by mixing the metal salt and the metal oxide with each other.

The metal oxide may be at least one selected from a group consisting of titanium (Ti) oxides and zirconium (Zr) oxides.

Since titania and zirconia may be easily hydrolyzed, when titania or zirconia is mixed with pure water without using separate additives, titanium hydrates or zirconium hydrates may be precipitated in a gel form.

The metal oxide hydrates may be washed, thereby removing impurities.

More specifically, the impurities present on surfaces of the particles may be removed by pressure-filtering the metal oxide hydrates to remove a residual solution and filtering the metal oxide hydrates while pouring pure water thereon.

Then, pure water and an acid or a base may be added to the metal oxide hydrate.

Pure water may be added to the metal oxide hydrate powder obtained after filtering and stirred with a high viscosity stirrer at a temperature of 0 to 60° C. for 0.1 to 72 hours, thereby preparing metal oxide hydrate slurry.

The acid or base may be added to the prepared slurry, wherein the acid or base may be used as a peptizer and added at a content of 0.00001 to 0.2 mole based on the content of the metal oxide hydrate.

The acid is not particularly limited as long as the acid is generally used. For example, hydrochloric acid, nitric acid, sulfuric acid, phosphoric acid, formic acid, acetic acid, polycarboxylic acid, and the like, may be used alone, or as a mixture of at least two thereof.

The base is not particularly limited as long as the base is generally used. For example, tetramethyl ammonium hydroxide, tetraethyl ammonium hydroxide, and the like, may be used alone or as a mixture thereof.

The metal salt may be barium hydroxide or a mixture of barium hydroxide and a rare earth salt.

The rare earth salt is not particularly limited, but, for example, scandium (Sc), yttrium (Y), lanthanum (La), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu), or the like may be used therefor.

In addition, at least one transition element selected from a group consisting of chromium (Cr), molybdenum (Mo), tungsten (W), manganese (Mn), iron (Fe), cobalt (Co), and nickel (Ni) may be further included in the mixture.

Forming of the perovskite particle core may be performed at a temperature of 60 to 150° C.

Next, the perovskite particle core may be injected into a hydrothermal reactor and hydrothermally treated, thereby growing the particle in the hydrothermal reactor.

Then, a metal salt aqueous solution may be injected into the hydrothermal reactor using a high pressure pump to prepare a mixed solution, followed by heating the mixed solution, thereby obtaining the dielectric grain having the perovskite structure represented by ABO₃.

The metal salt aqueous solution is not particularly limited, but may be, for example, at least one selected from a group consisting of metal nitrate aqueous solutions and metal acetate aqueous solutions.

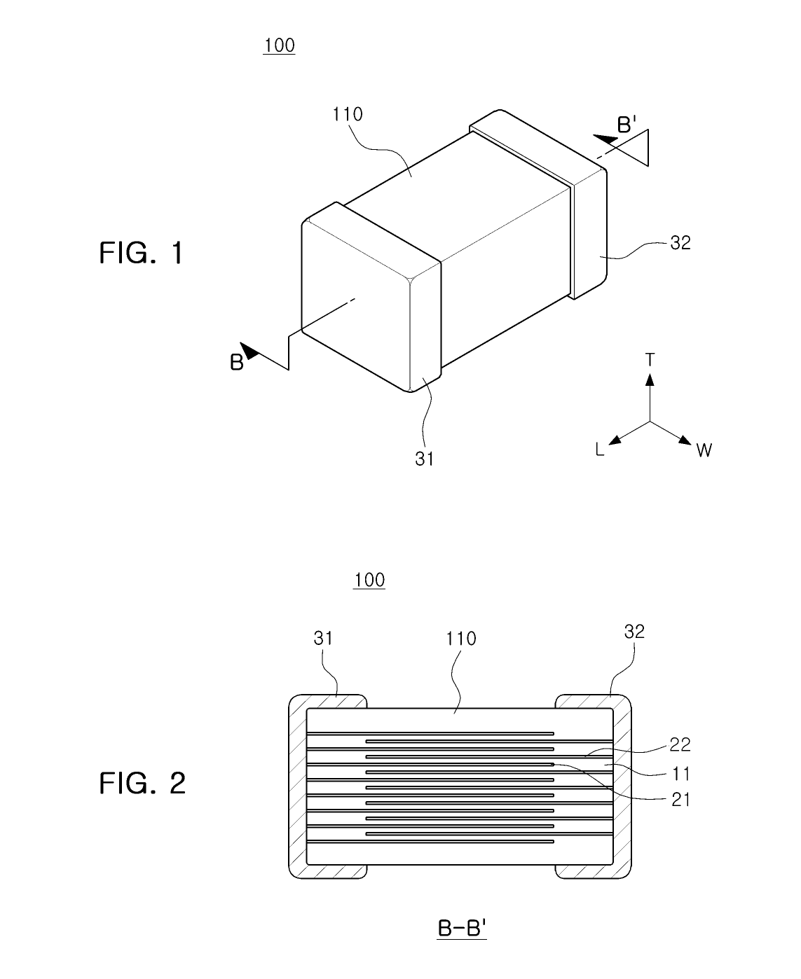

FIG. 1 is a perspective view schematically showing a multilayer ceramic capacitor according to an embodiment of the invention.

FIG. 2 is a cross-sectional view taken along line B-B′ of FIG. 1.

Referring to FIGS. 1 and 2, the multilayer ceramic electronic component according to the embodiment of the invention may include a ceramic body 110 including a dielectric layer 11 having an average thickness of 0.65 μm or less; and internal electrodes 21 and 22 disposed so as to face each other within the ceramic body 110, having the dielectric layer 11 interposed therebetweeen, wherein the dielectric layer 11 includes a dielectric composition including dielectric grains having a perovskite structure represented by ABO₃, the dielectric grain including a base material, in which at least one rare earth element RE is solid-solubilized in at least one of A and B, and a transition element TR, and a ratio (TR/RE) of the transition element to the rare earth element being 0.2 to 0.8.

Hereinafter, the multilayer ceramic electronic component according to the embodiment of the invention will be described. Particularly, a multilayer ceramic capacitor 100 will be described, but the invention is not limited thereto.

In the multilayer ceramic capacitor 100 according to the embodiment of the invention, a ‘length direction’ refers to an ‘L’ direction of FIG. 1, a ‘width direction’ refers to a ‘W’ direction of FIG. 1, and a ‘thickness direction’ refers to a ‘T’ direction of FIG. 1. Here, the ‘thickness direction’ is the same as a direction in which dielectric layers are laminated, that is, the ‘lamination direction’.

According to the embodiment of the present invention, a raw material forming the dielectric layer 11 is not particularly limited as long as sufficient capacitance may be obtained thereby, but may be, for example, barium titanate (BaTiO₃) powder.

The multilayer ceramic capacitor manufactured using the barium titanate (BaTiO₃) powder may have high permittivity at room temperature and excellent insulation resistance and withstand voltage characteristics, thereby improving reliability.

The multilayer ceramic capacitor 100 according to the embodiment of the invention may include the dielectric composition including the dielectric grain having the perovskite structure represented by ABO₃, the dielectric grain including a base material, in which at least one rare earth element (RE) is solid-solubilized in at least one of A and B, and the transition element TR, and the ratio (TR/RE) of the transition element to the rare earth element being 0.2 to 0.8, such that the multilayer ceramic capacitor may have high permittivity at room temperature and excellent insulation resistance and withstand voltage characteristics, thereby improving the reliability.

In a material forming the dielectric layer 11, various ceramic additives, organic solvents, plasticizers, binders, dispersing agents, and the like, may be applied to powder such as barium titanate (BaTiO₃) powder, or the like, according to an object of the invention.

The average thickness of the dielectric layer 11 is not particularly limited, but may be, for example, 0.65 μm or less.

The dielectric composition according to the embodiment of the invention may have improved realibility when the average thickness of the dielectric layer 11 is 0.65 μm or less as described above. That is, when the average thickness of the dielectric layer 11 of the multilayer ceramic capacitor using the dielectric composition is 0.65 μm or less, the reliability thereof may be excellent.

Further, the permittivity of the dielectric layer 11 is not particularly limited, but may be, for example, 6500 or more.

A description of features overlapped with those of the above-described dielectric composition will be omitted.

A material forming the first and second internal electrodes 21 and 22 is not particularly limited, but may be a conductive paste made of at least one of, for example, silver (Ag), lead (Pb), platinum (Pt), nickel (Ni), and copper (Cu).

The multilayer ceramic capacitor according to the embodiment of the invention may further include a first external electrode 31 electrically connected to the first internal electrode 21 and a second external electrode 32 electrically connected to second internal electrode 22.

The first and second external electrodes 31 and 32 may be electrically connected to the first and second internal electrodes 21 and 22 in order to form capacitance, and the second external electrode 32 may be connected to power having a potential different from that of the first external electrode 31.

A material of the first and second external electrodes 31 and 32 is not particularly limited as long as the first and second external electrodes 31 and 32 may be electrically connected to the first and second internal electrodes 21 and 22 in order to form capacitance. For example, the first and second external electrodes 31 and 32 may include at least one selected from a group consisting of copper (Cu), nickel (Ni), silver (Ag), and silver-palladium (Ag—Pd).

Hereafter, although the invention will be described in detail with reference to Inventive and Comparative Examples, the invention is not limited thereto.

In the Inventive Example, a dielectric composition including dielectric grains having a perovskite structure represented by ABO₃, the dielectric grain including a base material, in which at least one rare earth element (RE) is solid-solubilized in at least one of A and B, and a transition element TR, and a ratio (TR/RE) of the transition element to the rare earth element being 0.2 to 0.8, was prepared.

In the Comparative Example, a dielectric composition including dielectric grains having the same configuration was prepared equally to that in the Inventive Example except that the dielectric grain was prepared so as to be outside of the above-mentioned numerical range of the invention.

In the following Table 1, the insulation resistance levels, capacitance levels, and reliability of multilayer ceramic capacitors were compared, according to the ratios (TR/RE) of the transition element to the rare earth element included in the dielectric grain.

Insulation resistance (IR) was measured after applying a voltage of 6.3V for 60 seconds, and values measured for 20 samples were converted into a logarithmic mean value.

Capacitance was measured using a LCR meter at 1 kHz and 0.5V after thermally treating the dielectric composition for 24 hours and then 1 hour elapsed. In order to evaluate reliability, the number of defects generated at 130° C. and 9.45V for 4 hours in 40 samples was counted.

The capacitance measurement was performed by measuring capacitance of samples according to the 03A335 standard based on 2.85 as minimal capacitance.

When the number of defects in 40 samples was 20 or more, reliability was evaluated as “bad”

TABLE 1

| | | IR (Ω) | | | Evaluation |
|---|---|---|---|---|---|
| | TR/RE | 25° C. | 130° C. | Capacitance | of Reliability |
| 1* | 0.05 | 0.6 × 10⁶ | 0.1 × 10⁴ | 3.95 | Bad |
| 2* | 0.15 | 0.6 × 10⁷ | 0.1 × 10⁵ | 3.61 | Bad |
| 3 | 0.2 | 2.5 × 10⁷ | 1.5 × 10⁶ | 3.48 | Good |
| 4 | 0.5 | 1.6 × 10⁹ | 8.5 × 10⁶ | 3.10 | Good |
| 5 | 0.8 | 1.1 × 10⁹ | 5.5 × 10⁷ | 2.86 | Good |
| 6* | 0.85 | 2.5 × 10⁹ | 9.9 × 10⁷ | 2.65 | Good |
| 7* | 0.9 | 2.6 × 10⁹ | 1.0 × 10⁹ | 2.51 | Bad |
| 8* | 1.0 | 2.5 × 10⁹ | 1.1 × 10⁹ | 2.24 | Bad |

*Comparative Example

Referring to Table 1, it may be appreciated that in samples 1 and 2 in which the ratio (TR/RE) of the transition element to the rare earth element included in the dielectric grain was less than 0.2, a desired insulation resistance level was not obtained and there was a problem in terms of reliability.

It may be appreciated that in samples 6 to 8 in which the ratio (TR/RE) of the transition element to the rare earth element included in the dielectric grain was more than 0.8, a desired capacitance level was not obtained and there was a problem in terms of reliability.

On the other hand, it may be appreciated that in samples 3 to 5, which were multilayer ceramic capacitors manufactured using the dielectric grain satisfying the numerical range of the invention, desired insulation resistance level, high capacitance and reliability were obtained.

As a result, it may be appreciated that the multilayer ceramic capacitor according to the embodiment of the invention includes the dielectric composition including the dielectric grain having the perovskite structure represented by ABO₃, the dielectric grain including the base material, in which at least one rare earth element (RE) is solid-solubilized in at least one of A and B, and the transition element TR, and the ratio (TR/RE) of the transition element to the rare earth element being 0.2 to 0.8, such that permittivity at room temperature and capacitance are high, and reliability is excellent.

As set forth above, a multilayer ceramic electronic component using a dielectric composition according to embodiments of the invention may have excellent reliability and secure high permittivity.

While the present invention has been shown and described in connection with the embodiments, it will be apparent to those skilled in the art that modifications and variations can be made without departing from the spirit and scope of the invention as defined by the appended claims.

What is claimed is:

1. A dielectric composition comprising:
dielectric grains having a perovskite structure represented by ABO₃,
wherein the dielectric grain includes a base material, in which at least one rare earth element RE is solid-solubilized in at least one of A and B, and a transition element TR, and
a ratio (TR/RE) of the transition element to the rare earth element is 0.2 to 0.8.

2. The dielectric composition of claim 1, wherein a content of the rare earth element RE in the form of an oxide is 0.1 to 1.2 at %, based on the base material.

3. The dielectric composition of claim 1, wherein a content of the transition element TR in the form of an oxide is 0.02 to 0.8 at %, based on the base material.

4. The dielectric composition of claim 1, wherein A includes at least one selected from a group consisting of barium (Ba), strontium (Sr), lead (Pb), and calcium (Ca).

5. The dielectric composition of claim 1, wherein B includes at least one selected from a group consisting of titanium (Ti) and zirconium (Zr).

6. The dielectric composition of claim 1, wherein the rare earth element is at least one selected from a group consisting of scandium (Sc), yttrium (Y), lanthanum (La), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

7. The dielectric composition of claim 1, wherein the dielectric grain includes at least one selected from a group consisting of BaₘTiO₃ (0.995≦m≦1.010), (Ba₁₋ₓCaₓ)ₘ(Ti_{1-y}Zr_{y})O₃ (0.995≦m≦1.010, 0≦x≦0.10, 0<y≦0.20), and Baₘ(Ti₁₋ₓZrₓ)O₃ (0.995≦m≦1.010, x≦0.10).

8. A multilayer ceramic electronic component comprising:
a ceramic body including dielectric layers having an average thickness of 0.65 pm or less; and
internal electrodes disposed to face each other within the ceramic body, having the dielectric layer interposed therebetweeen,
wherein the dielectric layer includes a dielectric composition including dielectric grains having a perovskite structure represented by ABO₃, the dielectric grain including a base material, in which at least one rare earth element RE is solid-solubilized in at least one of A and B, and a transition element TR, and a ratio (TR/RE) of the transition element to the rare earth element being 0.2 to 0.8.

9. The multilayer ceramic electronic component of claim 8, wherein a content of the rare earth element RE in the form of an oxide is 0.1 to 1.2 at %, based on the base material.

10. The multilayer ceramic electronic component of claim 8, wherein a content of the transition element TR in the form of an oxide is 0.02 to 0.8 at %, based on the base material.

11. The multilayer ceramic electronic component of claim 8, wherein A includes at least one selected from a group consisting of barium (Ba), strontium (Sr), lead (Pb), and calcium (Ca).

12. The multilayer ceramic electronic component of claim 8, wherein B includes at least one selected from a group consisting of titanium (Ti) and zirconium (Zr).

13. The multilayer ceramic electronic component of claim 8, wherein the rare earth element is at least one selected from a group consisting of scandium (Sc), yttrium (Y), lanthanum (La), actinium (Ac), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

14. The multilayer ceramic electronic component of claim 8, wherein the dielectric grain includes at least one selected from a group consisting of BaₘTiO₃ (0.995≦m≦1.010), (Ba₁₋ₓCaₓ)ₘ(Ti_{1-y}Zr_{y})O₃ (0.995≦m≦1.010, 0≦x≦0.10, 0<y≦0.20), and Baₘ(Ti₁₋ₓZrₓ)O₃ (0.995≦m≦1.010, x≦0.10).

15. The multilayer ceramic electronic component of claim 8, wherein the dielectric layer has a permittivity of 6500 or more.
